(19) United States
(12) Patent Application Publication
(10) Pub. No.: US 2013/0328424 A1
(43) Pub. Date: Dec. 12, 2013

(54) ELECTRIC MOTOR

(71) Applicant: Takashi Goto, Tokyo (JP)

(72) Inventor: Takashi Goto, Tokyo (JP)

(73) Assignee: Mitsubishi Electric Corporation, Tokyo (JP)

(21) Appl. No.: 14/001,467

(22) PCT Filed: Jul. 8, 2011
(86) PCT No.: PCT/JP2011/003935

§ 371 Date: Aug. 23, 2013

(51) Int. Cl. H02K 5/18; H02K 5/22

(52) U.S. Cl. CPC H02K 5/18; H02K 5/22
USPC 310/64

(57) ABSTRACT

A power element 22 is mounted on a board 21 outside an electric motor body 10 when viewed from an axial direction X. Heat produced by the power element 22 is conducted to a heat mass 32 formed outside the electric motor body 10 when similarly viewed from the axial direction X in a portion opposed to the power element 22, and radiated from a board-side heat radiating fin 33, and is also conducted through an uneven structure 42 which surrounds the power element 22 and radiated from a cover 40.

### TECHNICAL FIELD

The present invention relates to a heat radiation structure of an electric motor equipped with an inverter board on which a power element and a control element is mounted.

### BACKGROUND ART

In a case where an inverter is equipped inside a housing in which a motor such as an induction motor is accommodated, a heat radiation structure for a power element having a large amount of heat generation is required. Accordingly, heat radiation of the power element has been conventionally enhanced such that a board on which only the power element is mounted is attached to a housing cover. In addition, a structure hard to conduct the heat of the power element is devised such that a control element relatively vulnerable to heat is mounted on another board and attached to the housing side (for example, see Patent Document 1).

### PRIOR ART DOCUMENTS

### Patent Documents

Patent Document 1: Japanese Patent Application Laid-open No. 2001-210980

### SUMMARY OF THE INVENTION

### Problems To Be Solved By The Invention

However, in a case where the boards of the power element and the control element are separated from each other as in Patent Document 1 described above, wirings for connecting the two boards are required, and hence there has been a problem such that the structure is complicated and increased in size. In addition, the amount of heat generation is increased in an electric motor having a large electrification current, and hence there has been a problem such that sufficient heat radiation thereof cannot be carried out by only the attachment of the power element to the housing cover.

The present invention is made to solve the problems as described above, and an object of the invention is to provide an electric motor equipped with a board on which a power element and a control element are mounted with enhanced heat radiation of the power element.

### Means For Solving The Problem

An electric motor of the present invention includes: an electric motor body; a board which is disposed on one end side of the electric motor body in an axial direction thereof, and on which a power element and a control element for controlling electrification of the electric motor body are mounted; and a housing which accommodates the electric motor body, and it is configured that the power element is mounted on a surface of the board on the side opposite to the electric motor body and outside the control element, and that the housing has a heat mass on the side of a surface of the board facing the electric motor body at a position opposed to the power element.

### Effect Of The Invention

According to the invention, the electric motor with enhanced heat radiation of the power element can be provided in such a manner that the heat produced by the power element is heat radiated to the heat mass.

### BRIEF DESCRIPTION OF THE DRAWINGS

FIG. 1 is a cross-sectional view showing a configuration of an electric motor according to Embodiment 1 of the present invention.

FIG. 2 is a plan view showing a configuration of an inverter board of the electric motor according to Embodiment 1.

FIG. 3 is a view for explaining a heat radiation structure of the electric motor according to Embodiment 1.

### BEST MODE FOR CARRYING OUT THE INVENTION

In the following, in order to explain the present invention in more detail, embodiments for carrying out the invention will be described with reference to the accompanying drawings. Embodiment 1.

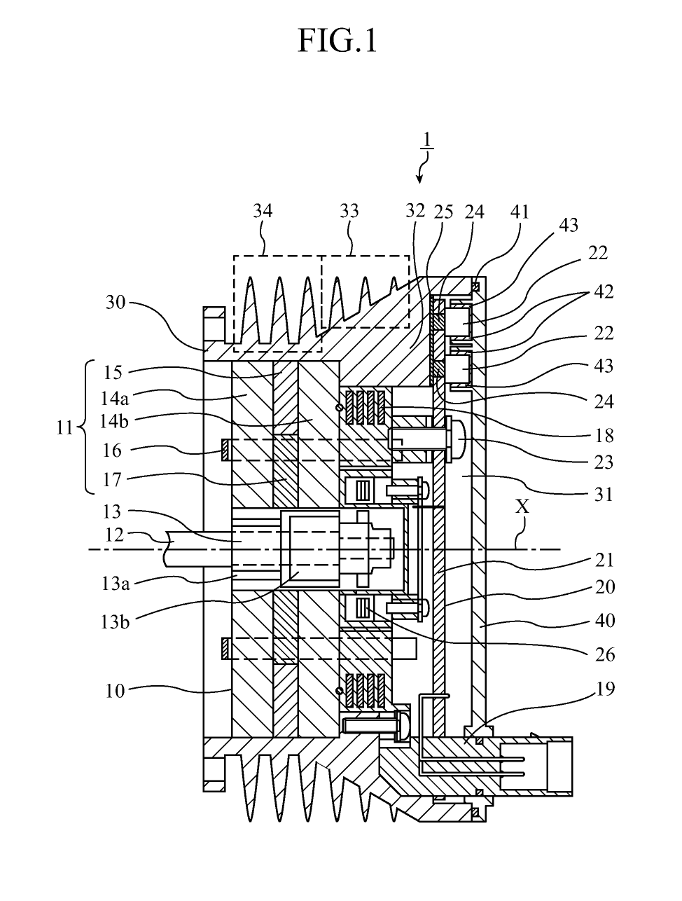

An electric motor 1 shown in FIG. 1 includes an electric motor body 10, an inverter section 20 which controls the energization of the electric motor body 10, a housing 30 which accommodates the electric motor body 10 and inverter section 20, and a cover 40 which covers an opening 31 of the housing 30.

Instead of a structural material (iron) to be commonly used, aluminum having a higher thermal conductivity is employed to constitute the housing 30 and cover 40. The electric motor body 10 is accommodated inside the cylindrical housing 30, and further the inverter section 20 is accommodated in the opening 31, and the cover 40 is attached thereto by a screw and the like. An O ring 41 is disposed between the housing 30 and cover 40 to seal a gap therebetween.

The thickness of the housing 30 is increased by extending the outer diameter of the region of the housing 30 which accommodates the inverter section 20, and a heat mass 32 is thereby formed outside the electric motor body 10 when viewed from an axial direction X. In addition, a board-side heat radiating fin 33 is vertically arranged on the outer surface of the housing 30 constituting the heat mass 32, and the heat conducted to the heat mass 32 from the inverter section 20 is heat radiated from the board-side heat radiating fin 33. Further, an electric motor body-side heat radiating fin 34 is arranged adjacent to the board-side heat radiating fin 33 and vertical on the outer surface of the housing 30 which covers the outer peripheral surface of the electric motor body 10 in the axial direction X, and the heat produced by the electric motor body 10 and the heat conducted to the heat mass 32 are heat radiated from the electric motor body-side heat radiating fin 34. The shared use of the heat mass 32 is devised such that the board-side heat radiating fin 33 and electric motor body-side heat radiating fin 34 are disposed adjacent to each other, and also the structure of the housing 30 is simplified. In addition, in a case where the protruding directions of the fins of the board-side heat radiating fin 33 and electric motor body-side heat radiating fin 34 are aligned in the same direction, the housing 30 is easily manufactured when cast through sand mold casting, for example.

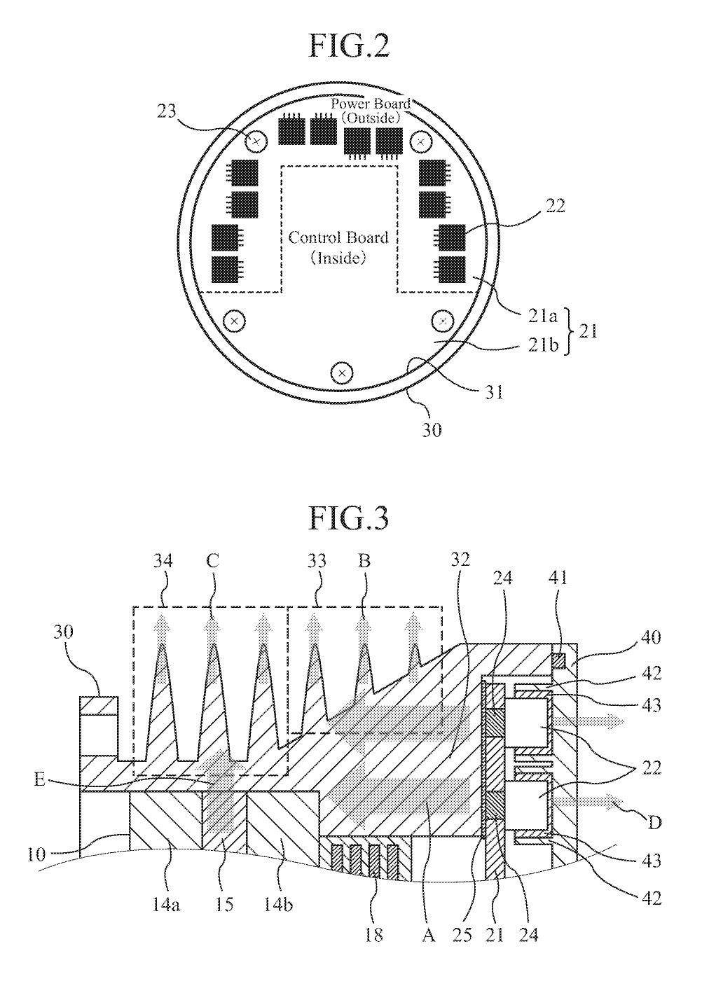

As shown in FIG. 2, in the inverter section 20, it is configured such that a plurality of power elements 22 (e.g., MOSFETs) are mounted on a surface of a disk-like board 21 facing the cover 40, and that a control element (not shown) is mounted on the opposite surface. A configuration to conduct easily the heat produced or given off by the power element 22 is achieved such that a power board region 21a on which the power elements 22 are mounted is disposed outside a control board region 21b on which the control element is mounted to thus bring the power elements 22 close to the housing 30. Note that as shown in FIGS. 1 and 2, the board 21 is disposed in the opening 31 on one end side of the electric motor body 10 in the axial direction X, and is fixed to the housing 30 by a plurality of screws 23.

Further, the power elements 22 are heat radiated with mounted outside the electric motor body 10 when viewed from the axial direction X, and with opposed to the heat mass 32 formed outside the electric motor body 10 when similarly viewed from the axial direction X. When the power elements 22 is mounted outside the electric motor body 10, the distance from the power element 22 to the board-side heat radiating fin 33 (described later) is reduced, thereby enhancing the heat radiation. Further, in order to enhance the heat radiation from the power element 22 to the heat mass 32, thermal connection thereof is enhanced such that a copper inlay (metal member) 24 having a high thermal conductivity is press-fit in the portion of the board 21 on which the power element 22 is mounted, and that a heat conductive gel (heat conductive member) 25 having a high thermal conductivity is applied to a face where the board 21 and heat mass 32 abut on each other. Note that the metal member press-fitted in the board 21 is not limited to the one made of copper, and may be any member at least higher in thermal conductivity than the member constituting the board 21. In addition, the heat conductive member sandwiched between the board 21 and heat mass 32 is not limited to the gel-like member, and may be a sheet-like member or the like. Further, the copper inlay 24 and the heat conductive gel 25 are not essential, and may be omitted, or only one of them may be provided.

On the other hand, the upper surface of the power element 22 abuts on the cover 40 to be thereby heat radiated. Further, an uneven structure 42 that surrounds the side of the power element 22 is formed on the surface of the cover 40 facing the inverter section 20 side, which enables to conduct easily the heat produced by the power element 22 to the cover 40. Furthermore, the uneven structure 42 is preferably filled with a heat conductive gel (heat conductive member) 43 having a higher thermal conductivity. In such a way, a large contact area thereof can be secured such that not only the upper surface of the power element 22 but also the side thereof is brought into contact with the cover 40, and hence it is possible to enhance a heat radiation rate from the cover 40. Note that a gap should be provided such that no tip portion of the uneven structure 42 is come into contact with the board 21 in a case where the cover 40 and uneven structure 42 made of aluminum are thermally expanded.

In a case where the heat radiation rate of the power element 22 is further enhanced, it is preferable that another heat conductive member having a higher thermal conductivity be used, or the thickness of the heat conductive member be thinned to thereby reduce the clearance between the board 21 and heat mass 32, and the clearance between the power element 22 and cover 40.

The electric motor body 10 includes a stator 11 which is press-fitted in and fixed to the housing 30, a shaft 12 which is supported to be rotatable about the axial direction X, a rotor 13 which causes the shaft 12 to rotate, and a connection plate 18. The stator 11 is constituted by two stator cores 14a and 14b, a magnet 15 disposed between the stator cores 14a and 14b, a plurality of coils 16 (U-phase, V-phase, and W-phase), and a mold section 17 in which these are integrated with a resin member. The end portions of the coils 16 extend through the mold section 17 to protrude toward the inverter section 20, and are connected to the connection plate 18 molded with the resin member. The connection plate 18 is connected to the power element 22 and a connector section 19.

In the rotor 13, protrusions which protrude outward in a radial direction are formed at two locations at intervals of 180 degrees, and the protrusions are put in a condition displaced by 90 degrees midway in the axial direction X (protrusions 13a and 13b). The protrusions 13a and 13b are magnetized by the action of the magnetic force of the magnet 15. When DC power is supplied to the inverter section 20 via the connector section 19 from an external power supply (not shown), the control element of the inverter section 20 acquires a signal indicative of the rotation position of the shaft 12 from a position detection sensor 26 provided in the vicinity of the end portion of the shaft 12, controls the switching operation of the power element 22 based on that signal to convert a direct current to a three-phase alternating current of the U phase, V phase, and W phase, and then supplies the resultant to the coils 16 through the connection plate 18. Then, the stator 11 is magnetized according to the direction of the current flown in the coils 16, a rotating magnetic field is generated around the rotor 13 on which the magnetic force of the magnet 15 acts, and the rotor 13 is rotationally driven.

The shaft 12 is fixed to the rotor 13, and the shaft 12 is integrally rotated with the rotor 13. For example, in a case where the electric motor 1 is applied to an automobile turbocharger, an electric compressor, and so on, the shaft 12 is coupled to the rotating shaft of a turbine (what is called an impeller), and the turbine is rotationally driven by the electric motor 1.

Next, a heat radiation path of the electric motor 1 will be described.

FIG. 3 is a view for explaining the heat radiation path of the electric motor 1, and enlarges and shows the vicinity of the power element 22 of the electric motor 1 shown in FIG. 1.

The heat produced by the power element 22 is conducted to the heat mass 32 via the copper inlay 24 and heat conductive gel 25 (indicated by an arrow A in FIG. 3), and is heat radiated from the board-side heat radiating fin 33 and electric motor body-side heat radiating fin 34 which are thermally connected to the heat mass 32 (indicated by arrows B and C in FIG. 3). In addition, the heat produced by the power element 22 is also heat radiated from the cover 40 via the heat conductive gel 43 and uneven structure 42 (indicated by an arrow D in FIG. 3).

Further, the heat produced by the electric motor body 10 is conducted to the electric motor body-side heat radiating fin 34 via the housing 30 around the electric motor body 10 (indicated by an arrow E in FIG. 3), and is heat radiated from the electric motor body-side heat radiating fin 34 (indicated by an arrow C in FIG. 3).

Note that as an illustration thereof is omitted, it may be devised that the effect of the heat radiation is further enhanced by circulating a cooling medium (cooling wind, cooling water, and so on) around the board-side heat radiating fin 33 and the electric motor body-side heat radiating fin 34.

As described above, according to Embodiment 1, it is configured that the electric motor 1 includes: the electric motor body 10; the board 21 which is disposed on one end side of the electric motor body 10 in the axial direction X, and on which the power element 22 and control element for controlling electrification of the electric motor body 10 are mounted; and the housing 30 which accommodates the electric motor body 10 and the board 21, wherein the power element 22 is mounted on the surface of the board 21 on the side opposite to the electric motor body 10 and outside the control element, and wherein the housing 30 has the heat mass 32 on the side of the surface of the board 21 facing the electric motor body 10 at a position opposite the power element 22. For this reason, it becomes possible to radiate the heat produced by the power element 22 to the heat mass 32, so that the electric motor 1 can be provided with increased heat radiation of the power element 22.

In addition, it is implemented that the power element 22 is actively cooled to thus suppress an increase in temperature thereof, and hence the life of the power element 22 can be increased, and also an adverse effect on the control element can be averted.

Further, the power element 22 and the control element can be mounted on the one board 21, and hence simplification and downsizing of the structure become possible as compared with a case where the elements are mounted on separate boards like a conventional one.

Furthermore, the power element 22 can be actively cooled, and hence it becomes possible to increase the permissible temperature of the environment in which the electric motor 1 is used. Moreover, the rated loss of the electric motor 1 is generally determined on the basis of a level of power consumption with respect to a predetermined temperature increase range; thus, when the temperature increase thereof is suppressed, a permissible power consumption thereof can be increased, and it is further effected that a time required for an increase to a predetermined temperature can be prolonged, so that it becomes possible to prolong an electrification time thereof. Thus, it is also possible to improve the capability of the electric motor 1.

In addition, according to Embodiment 1, it is configured that the electric motor 1 includes: the copper inlay 24 that passes through the portion of the board 21 on which the power element 22 is mounted and has the thermal conductivity higher than that of the board 21; and the heat conductive gel 25 which is disposed between the copper inlay 24 and the heat mass 32, and conducts heat of the power element 22 to the heat mass 32 via the copper inlay 24. For this reason, it is possible to further enhance a heat radiation rate thereof, thereby increasing the life of the power element 22 and improving the capability of the electric motor 1.

Further, according to Embodiment 1, since it is configured that the power element 22 is disposed outside the electric motor body 10 when viewed from the axial direction X, it can be thermally connected to the heat mass 32 which is disposed outside the electric motor body 10 when similarly viewed from the axial direction X, thereby enhancing the heat radiation. Furthermore, with an arrangement such that the power element 22 becomes closer to the board-side heat radiating fin 33 formed on the outer surface of the housing 30, the heat radiation can also be improved.

Moreover, according to Embodiment 1, it is configured that the housing 30 has the board-side heat radiating fin 33 on the outer surface of the portion constituting the heat mass 32, and also has the electric motor body-side heat radiating fin 34 on the outer surface of the portion covering the outer peripheral surface of the electric motor body 10 in the axial direction X at the position adjacent to the board-side heat radiating fin 33, and that the protruding directions of the board-side heat radiating fin 33 and the electric motor body-side heat radiating fin 34 are formed the same. For this reason, it is possible to thermally connect the board-side heat radiating fin 33 and electric motor body-side heat radiating fin 34 to the heat mass 32, which enables to achieve the sharing, and therefore simplification of the structure of the housing 30 and reduction of a manufacturing cost thereof become possible. In addition, since the protruding directions of the fins are adapted the same, leading directions of a heat radiating medium can also be adapted the same.

In addition, according to Embodiment 1, it is configured that the electric motor 1 includes the cover 40 which covers the surface of the board 21 on the side opposite to the electric motor body 10, and which is thermally connected to the power element 22 mounted on that surface via the heat conductive gel 43. For this reason, the heat radiation can be carried out in both the directions such that the power element 22 is sandwiched between the heat mass 32 and cover 40, which makes it possible to further enhance the heat radiation rate.

Further, according to Embodiment 1, it is configured such that the cover 40 has the uneven structure 42 which surrounds the side of the power element 22, and hence it is possible to increase the contact area between the power element 22 and the cover 40 for heat radiation to further enhance the heat radiation rate.

Furthermore, according to Embodiment 1, the housing 30 and cover 40 are made of aluminum having a higher thermal conductivity, and hence the heat radiation rate can be enhanced.

However, in the above description, there is shown an example of the inverter section 20 which generates a three-phase alternating current using the twelve power elements 22, but it is not limited thereto; the number of power elements 22 may be appropriately determined according to the configuration of the electric motor 1.

In addition to the above, it is possible to modify any component of the embodiments, or omit any component in the embodiments within the scope of the invention.

### INDUSTRIAL APPLICABILITY

As described above, since the electric motor according to the present invention is configured to enhance the heat radiation of the power element for the inverter, it is suitable for use in an electric motor which rotationally drives a automobile turbocharger, an electric compressor, and so on to be exposed to a high temperature.

### EXPLANATION OF REFERENCE NUMERALS

1 electric motor, 10 electric motor body, 11 stator, 12 shaft, 13 rotor, 13a, 13b protrusion, 14a, 14b stator core, 15 magnet, 16 coil, 17 mold section, 18 connection plate, 19 connector section, 20 inverter section, 21 board, 21a power board region, 21b control board region, 22 power element, 23 screw, 24 copper inlay, 25, 43 heat conductive gel, 26 position detection sensor, 30 housing, 31 opening portion, 32 heat mass, 33 board-side heat radiating fin, 34 electric motor body-side heat radiating fin, 40 cover, 41 O ring, 42 uneven structure.

1. An electric motor comprising:
an electric motor body;
a board which is disposed on one end side of the electric motor body in an axial direction thereof, and on which a power element and a control element for controlling electrification of the electric motor body are mounted on the same plane; and
a housing which accommodates the electric motor body,
wherein the power element is mounted on a surface of the board on the side opposite to the electric motor body and outside the control element, and
wherein the housing has a heat mass on the side of a surface of the board facing the electric motor body at a position opposed to the power element.

2. The electric motor according to claim 1, further comprising:
a metal member which passes through a portion of the board on which the power element is mounted, and has a heat conductivity higher than that of the board; and
a heat conductive member which is disposed between the metal member and the heat mass, and conducts heat of the power element to the heat mass via the metal member.

3. The electric motor according to claim 1, wherein the power element is disposed outside the electric motor body when viewed from the axial direction.

4. The electric motor according to claim 1, wherein the housing has a board-side heat radiating fin on an outer surface of a portion constituting the heat mass, and has an electric motor body-side heat radiating fin on an outer surface of a portion covering an outer peripheral surface of the electric motor body in the axial direction at a position adjacent to the board-side heat radiating fin, and wherein a protruding direction of the board-side heat radiating fin is the same as that of the electric motor body-side heat radiating fin.

5. The electric motor according to claim 1, further comprising a heat radiating cover which covers the surface of the board on the side opposite to the electric motor body, and is thermally connected to the power element mounted on the said surface.

6. The electric motor according to claim 5, wherein the heat radiating cover has an uneven structure which surrounds a side of the power element.

7. The electric motor according to claim 5, wherein the heat radiating cover is made of aluminum.

8. The electric motor according to claim 1, wherein the housing is made of aluminum.
